(19) United States
(12) Patent Application Publication
(10) Pub. No.: US 2023/0095763 A1
(43) Pub. Date: Mar. 30, 2023

(54) SYSTEM AND METHOD FOR FRACTURE DYNAMIC HYDRAULIC PROPERTIES ESTIMATION AND RESERVOIR SIMULATION

(71) Applicants: SAUDI ARABIAN OIL COMPANY, Dhahran (SA); King Abdullah University of Science and Technology, Thuwal-Jeddah (SA)

(72) Inventors: Marwah Mufid AlSinan, Dhahran (SA); Xupeng He, Thuwal (SA); Ryan Santoso, Thuwal (SA); Hyung Tae Kwak, Dhahran (SA); Hussein Hoteit, Thuwal (SA)

(73) Assignees: SAUDI ARABIAN OIL COMPANY, Dhahran (SA); King Abdullah University of Science and Technology, Thuwal-Jeddah (SA)

(21) Appl. No.: 17/489,364

(22) Filed: Sep. 29, 2021

(51) Int. Cl. G01V 99/00; G01V 1/50; E21B 47/002; G06T 17/05; G06T 3/40; G06T 7/73; G06N 3/08

(52) U.S. Cl. CPC G01V 99/005; G01V 1/50; E21B 47/0025; G06T 17/05; G06T 3/4053; G06T 7/75; G06N 3/08; G01V 2210/642; G01V 2210/646; G01V 2210/74; G06T 2207/20081; G06T 2207/20084; G06T 2207/30181

(57) ABSTRACT

A method for fracture dynamic hydraulic properties estimation and reservoir simulation may include obtaining a first set of images of a first fracture. The method may include obtaining a first set of fracture detections from the first set of images, generating a plurality of numerical calculations based on the first set of fracture detections, and generating a second model based on the plurality of numerical calculations and the first set of fracture detections. The method may further include obtaining a second set of images of a second fracture of a new reservoir, generating a second set of fracture detections of the second fracture, and generating dynamic hydraulic estimations of the second fracture. The method may also include generating a three-dimensional reservoir simulation and determining a plurality of recovery schemes for the new reservoir.

### BACKGROUND

Fractures typically present naturally in rocks and often exhibit high conductive pathways for fluids. Hydraulic properties of the natural fractures are essential parameters for modeling fluid flow and transport in fractured formations. Current technologies mostly focus on capturing static geometric properties of the natural fractures, such as strike and dip angle. However, dynamic hydraulic properties, such as fracture permeability and hydraulic aperture, cannot be calculated directly because they depend on fracture conductivity which requires special and costly measurements. In addition to these, due to heterogeneous nature of the natural fractures, for example, non-uniform apertures, roughness, and tortuosity, it is often challenging to estimate the dynamic hydraulic properties of the natural fractures. However, estimating the dynamic hydraulic properties of the natural fractures is vital to assess fluid flow behavior in subsurface rock formation. When modeling hydrocarbon reservoirs, fractures conductivity, which is captured by the fracture permeability and effective hydraulic aperture, is important to evaluate recovery performance of different recovery schemes, including waterflood and enhanced oil recovery.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for fracture dynamic hydraulic properties estimation and reservoir simulation that includes obtaining, by a computer processor, a first set of high-resolution images of a first fracture. The method includes obtaining, by the computer processor and a first model, a first set of fracture detections based on the first set of high-resolution images. The method includes generating, by the computer processor, a plurality of numerical calculations based on the first set of fracture detections of the first fracture. The method includes generating, by the computer processor, a second model based on the plurality of numerical calculations and the first set of fracture detections. The method includes obtaining, by the computer processor, a second set of high-resolution images of a second fracture of a new reservoir. The method includes generating, by the computer processor using the first model, a second set of fracture detections of the second fracture. The method includes generating, by the computer processor using the second model, dynamic hydraulic estimations of the second fracture. The method includes generating, by the computer processor and a third model, a three-dimensional (3D) reservoir simulation of the new reservoir based on the second set of high-resolution images and the dynamic hydraulic estimations of the second fracture. The method further includes determining, by the computer processor and using the dynamic hydraulic estimations of the second fracture and the 3D reservoir simulation, a plurality of recovery schemes for the new reservoir.

In one aspect, embodiments relate to a system for fracture dynamic hydraulic properties estimation and reservoir simulation. The system includes a plurality sets of high-resolution images for a plurality fractures. The system includes a fracture manager comprising a computer processor. The fracture manager obtains a first set of high-resolution images of a first fracture. The fracture manager obtains, using a first model, a first set of fracture detections based on the first set of high-resolution images. The fracture manager generates a plurality of numerical calculations based on the first set of fracture detections of the first fracture. The fracture manager generates a second model based on the plurality of numerical calculations and the first set of fracture detections. The fracture manager obtains a second set of high-resolution images of a second fracture of a new reservoir. The fracture manager generates, using the first model, a second set of fracture detections of the second fracture. The fracture manager generates using the second model, dynamic hydraulic estimations of the second fracture. The fracture manager generates, using a third model, a three-dimensional (3D) reservoir simulation of the new reservoir based on the second set of high-resolution images and the dynamic hydraulic estimations of the second fracture. The fracture manager further determines, using the dynamic hydraulic estimations of the second fracture and the 3D reservoir simulation, a plurality of recovery schemes for the new reservoir.

In one aspect, embodiments relate to A non-transitory computer readable medium storing instructions. The instructions obtain a first set of high-resolution images of a first fracture. The instructions obtain a first set of fracture detections based on the first set of high-resolution images. The instructions generate a plurality of numerical calculations based on the first set of fracture detections of the first fracture. The instructions generate a second model based on the plurality of numerical calculations and the first set of fracture detections. The instructions obtain a second set of high-resolution images of a second fracture of a new reservoir. The instructions generate a second set of fracture detections of the second fracture. The instructions generate dynamic hydraulic estimations of the second fracture. The instructions generate a three-dimensional (3D) reservoir simulation of the new reservoir based on the second set of high-resolution images and the dynamic hydraulic estimations of the second fracture. The instructions further determine a plurality of recovery schemes for the new reservoir.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a reservoir system in accordance with one or more embodiments.

FIG. 2 shows a system in accordance with one or more embodiments.

FIG. 3 shows a workflow in accordance with one or more embodiments.

FIG. 4 shows an example of model workflows in accordance with one or more embodiments.

FIGS. 5A shows a flowchart in accordance with one or more embodiments.

FIGS. 5B-5C show workflows expanding on one or more of the steps shown in FIG. 5A.

FIG. 5D shows a machine learning algorithm in accordance with one or more embodiments.

FIG. 6 shows a computing device in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As hydrocarbon discoveries are declining significantly, there is a compelling need in the gas and oil industry to enhance oil recovery from maturing fields and to develop challenging resources, such as low-quality rock reservoirs, naturally-fractured reservoirs, and shales. These reservoirs are multiple continuum where fluid flow is governed by a complex interplay between fractures and matrix systems. Modeling such fractures is crucial to understand matrix-fracture interactions and recovery mechanisms.

A fracture, also referred as a natural fracture, is a crack or surface of breakage within rock. In conventional hydrocarbon reservoirs, understanding the fractures is crucial to recovery the oil and gas behavior. For example, fractures can enhance rock permeability and water injectivity. Thus, fractures are induced mechanically in reservoirs to boost hydrocarbon flow. On the other hand, fractures may lead to early water breakthrough and poor sweep. In unconventional reservoirs, fractures are the primary conduits for flow and production.

High-resolution wellbore images are commonly used to characterize fractured reservoirs. In particular, high-resolution borehole images can reduce uncertainties when realizing heterogeneous rock matrix and embedded discrete fracture network (DFN). In particular, a DFN refers to a computational model that represents the geometrical properties of each individual fracture, and the topological relationships between individual fractures. Further, reservoir modeling requires both static geometric properties (such as fracture density, orientation, dip, and strike), and dynamic hydraulic properties (such as fracture permeability and effective aperture). However, existing techniques focus on detecting the static geometric properties. None of the existing techniques discusses estimating the dynamic hydraulic properties by using high-resolution wellbore images. In addition, traditional techniques and methods require physical measurements and simulations to determine the fracture properties. Due to complexity and expensive cost, these measurements and simulations can only be done on a limited scale.

This disclosure provides an automatic procedure that estimates the dynamic hydraulic properties of a fracture by using high-resolution wellbore images. The disclosure provides an efficient and cost-effective procedure that incorporate big data of wells, cores, and outcrops based on machine-learning (ML) models. Embodiments disclosed herein also provide workflows that aim at capturing fracture data from different sources and integrate a reservoir simulation model accordingly. In particular, the provided workflows can be integrated with existing workflows.

In general, embodiments of the disclosure include a system and a method that automatically process fracture detections and dynamic hydraulic properties estimation from high-resolution image. The present disclosure relates to a method of collecting high-resolution images, detecting fractures from the collected images, and estimating dynamic hydraulic properties from the detected fractures. More specifically, a new workflow based on machine learning techniques aims to automate the process of fracture detection from high-resolution wellbore images, and other images of rock cores and outcrops, and estimation of the hydraulic properties of natural fractures. In some embodiments, the method may utilize a first ML model to generate a plurality of detected fractures. Further, the method may utilize the plurality of detected fractures to generate a second ML model that estimates dynamic hydraulic properties. Additionally, the method may include generating dynamic hydraulic properties of a fracture utilizing the second ML model. Moreover, the method may include updating the second ML model based on newly collected high-resolution images and fracture data. Furthermore, the method may utilize the collected high-resolution images and the estimated dynamic hydraulic properties to construct reservoir simulation model.

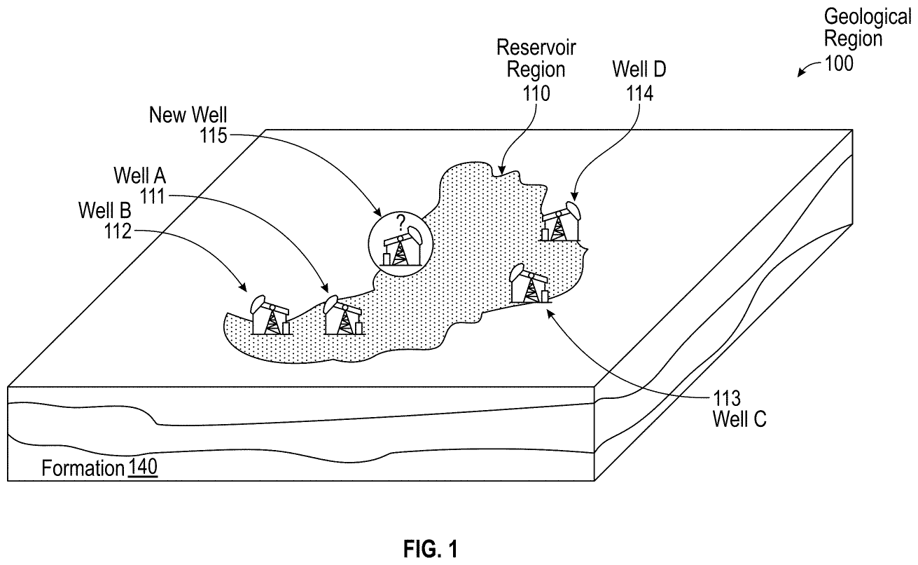

FIG. 1 shows a schematic diagram in accordance with one or more embodiments. As illustrated in FIG. 1, FIG. 1 shows a geological region (e.g., geological region (100)) that may include one or more reservoir regions (e.g., reservoir region (110)) with a plurality of wells (e.g., well A (111), well B (112), well C (113), and well D (114)) and a new well (e.g., new well (115)). As shown in FIG. 1, the wells (111, 112, 113, 114) and the new well (115) are disposed above a formation (e.g., formation (140)). In alternate embodiments, the new well (115) and the wells (111, 112, 113, 114) may not necessarily belong to a same reservoir region, and thus, may not be adjacent wells in the same geological region, but may be distant from each other and part of different geological regions. In some embodiments, the wells (111-114) may be used as training wells from which training data is collected. For example, in some embodiments, the new well (115) may intersect a fracture. Such training data, including images of wellbore interceptions with fractures, may be collected to train an estimation model as further described below. Wellbore images collected form the new well (115) are used to estimate the dynamic hydraulic properties and generate the reservoir simulation for the new fracture.

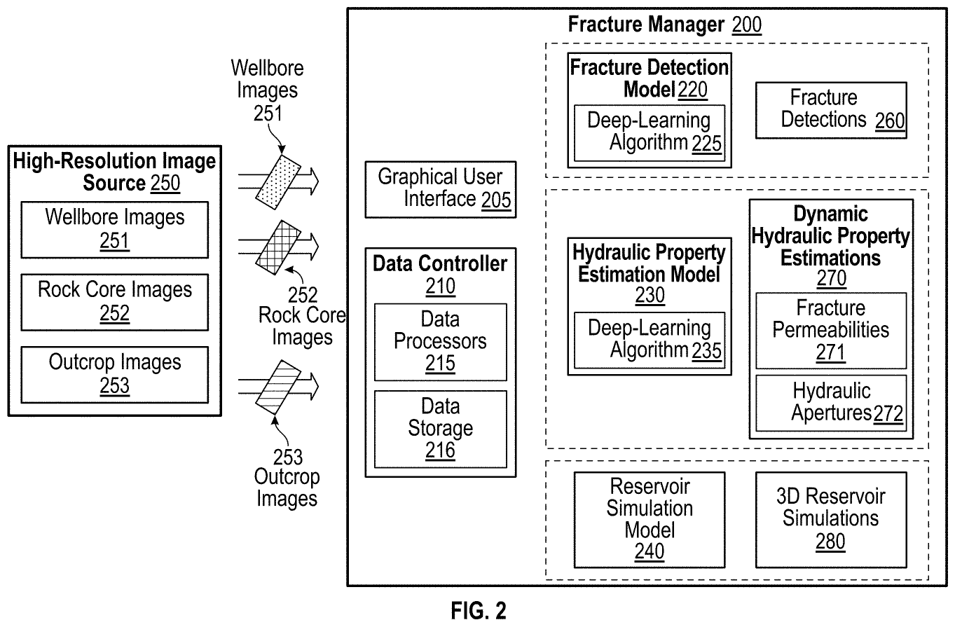

Turning to FIG. 2, FIG. 2 shows a block diagram of a system in accordance with one or more embodiments. As shown in FIG. 2, a high-resolution image source (e.g., high-resolution image source (250)) provides a plurality of high-resolution images for a fracture manager (e.g. fracture manager (200)). A high-resolution images source may refer to any device, i.e., a camera, sensor device, etc. that produces high-resolution images. More specifically, a high-resolution images source may be a database located in a disk or a remote serve, live measurements from physical devices, or a(n) file/data sheet/XML file within a computer program, etc. Types of high-resolution images sources may differ according to the purposes or functions of an application. In one or more embodiments, the high-resolution images may be stored on a computer, in a repository or in any other suitable data structure. In some embodiments, the high-resolution image source (250) may include wellbore images (e.g., wellbore images (251)), rock core images (e.g., rock core images (252)), and outcrop images (e.g., outcrops images (253)). In some embodiments, the wellbore images (251), the rock core images (252), and the outcrop images (253) may be collected from one or more of the various wells (111, 112, 113, 114, 115) of the reservoir formation (140). In some embodiments, the high-resolution image source (250) may be searchable public database and/or company-owned database. Further, the images included in the high-resolution image source (250) may be collected from different wellbores and/or different types of rock from multiple reservoirs at various depths.

Specifically, the wellbore images (251) may refer to high-resolution images of wellbore interceptions. For example, the wellbore images (251) may reflect wellbore interceptions of the one or more wells (111-115) in FIG. 1 at various depths. These images may be acquired by different technologies, such as resistivity and acoustic logs, that have capabilities to detect fractures or faults in rock formation. In particular, in a wellbore image, a fracture typically appears as a sinusoidal shaped feature with visible contrast in the imaging signal reflecting discontinuity in rock property. The sinusoidal shape is a result of folded circumference of the fracture plane intercepting the wellbore. The rock core images (252) may refer to high- resolution images of rock core samples. Rock cores may refer to core samples of a naturally-occurring substance that are obtained by drilling into the substance, such as rock and bedrock. The outcrop images (253) may refer to high-resolution images of rock outcrops. Outcrops may refer to visible exposure of bedrock or ancient superficial deposits on the surface of the Earth, and allows direct observation and sampling of the bedrock. In some embodiments, these high-resolution images may be captured by cameras and/or sensors containing arrays of electronic photodetectors. As such, these images are digitalized and are stored as computer files ready for further digital processing and viewing. In one or more embodiments, the wellbore images (251), the rock core images (252), and the outcrop images (253) are utilized to build three-dimensional (3D) reservoir simulation that will be described below. More specifically, in order to build a specific 3D reservoir simulation, the rock core images (252) and the outcrop images (253) are taken from the same reservoir or from an analogous reservoir or outcrop. In addition, rock core images (252) may be taken from different wellbores to improve accuracy an comprehension of 3D reservoir simulations.

Keeping with FIG. 2, the fracture manager (200) may be software and/or hardware implemented on a network, such as a network controller, and includes functionalities for detecting and/or managing fractures. For example, a fracture manager may collect image data of various wells, process the collected image data, generate fracture detections and dynamic hydraulic property estimations, and/or generate 3D reservoir simulations.

In some embodiments, the fracture manager (200) may include a graphical user interface (GUI) (e.g., graphical user interface (GUI) (205)) that receives instructions and/or inputs from users. More specifically, the users may enter various types of instructions and/or inputs via the GUI (205) to start certain actions, such as calculating, evaluating, selecting, and/or updating data or parameters.

In some embodiments, the fracture manager (200) may include a data controller (e.g., data controller (210)). The data controller (210) may be software and/or hardware implemented on any suitable computing device, and may include functionalities for collecting various data from the high-resolution images source (250) and processing the collected data. For example, the data controller (210) may collect the wellbore images (251), the rock core images (252), and the outcrop images (253) from the high-resolution image resource (250). The data controller may include data processors (e.g., data processors (215)) and data storage (e.g., data storage (216)). Specifically, the data processors (215) process the data collected from the high-resolution images source (250) as well as the data stored in the data storage (216). The data storage (216) may store the various data collected from the high-resolution images source (250), and other data and parameters for the other sections and functionalities of the fracture manager (200).

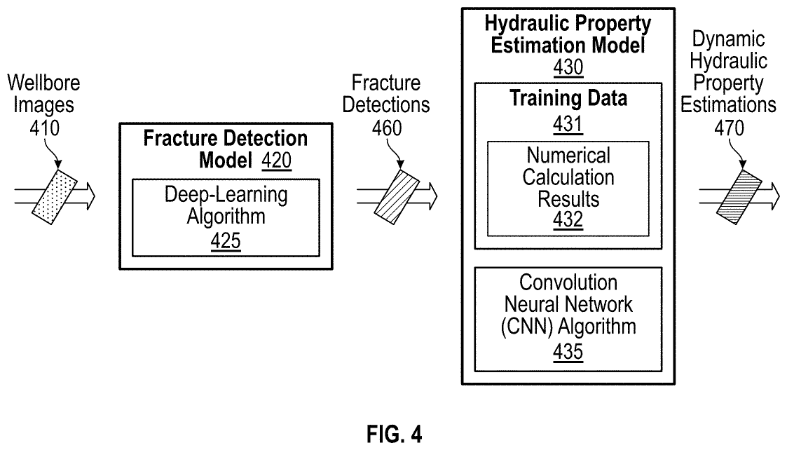

Keeping with FIG. 2, the fracture manager (200) may include a fracture detection model (e.g., fracture detection model 220) that utilizes one or more deep-learning algorithms (e.g., deep-learning algorithm (225)) to detect fractures from the wellbore images (251) and generate fracture detections (e.g., fracture detections (260)) accordingly. Details of the fracture detection model (220) and the deep-learning algorithm(s) (225) are explained below in FIG. 4 and the accompanying description.

Further, the fracture manager (200) may include a hydraulic property estimation model (e.g., hydraulic property estimation model (230)) that utilizes one or more deep-learning algorithms (e.g., deep-learning algorithm (235)) to estimate dynamic hydraulic properties of a fracture (e.g., dynamic hydraulic property estimations (270)). In particular, the hydraulic property estimation model estimates permeabilities (e.g., fracture permeabilities (271)) and hydraulic apertures (e.g., hydraulic apertures (272)) of the detected fractures. In particular, the fracture permeabilities may be associated with the secondary porosity created by an open fractures. In many reservoirs, the fracture permeabilities can be a major controlling factor of flow of fluids. Further, the fracture permeabilities are critical parameters in reservoir simulations and ultimately impact future determinations based on the simulation results.

Further, the hydraulic apertures may refer to effective perpendicular width of the open fracture. More details about the hydraulic property estimation model (230) and the deep-learning algorithm (235) are provided below in FIG. 4 and the accompanying description.

Continuing with FIG. 2, the fracture manager (200) may include a reservoir simulation model (e.g., reservoir simulation model (240)). In some embodiments, the reservoir simulation model (240) utilizes the DFN generated by compiling data from the wellbore images (251), the rock core images (252), and the outcrop images (253), as well as the dynamic hydraulic property estimations (270) to construct 3D reservoir simulations (e.g., 3D reservoir simulations (280)). The 3D reservoir simulations (280) represent reservoirs corresponding to these images.

The 3D reservoir simulations are highly related to reservoir development. Specifically, generated to evaluate the amount of hydrocarbon in a reservoir, such as original oil in place and recoverable reserves, which can be used to evaluate profitability of the reservoir and to design future development plans of the reservoir. For example, reservoir simulation models can be used to predict field performance and ultimate recovery for various field development scenarios, such as well orientation, hydraulic fracturing, enhanced oil recovery, and etc., to evaluate effects of different operational conditions recovery and to compare economics of different recovery methods. More specifically, the 3D reservoir simulations are used to determine, for example, how to develop a field to maximize economic recovery, the best enhanced recovery scheme for the reservoir, the best completion scheme for wells, and reservoir production source.

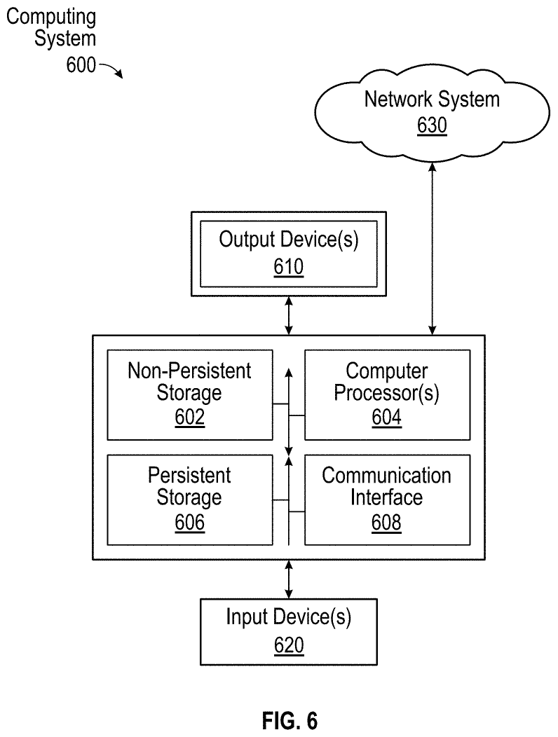

In some embodiments, the high-resolution image source (250) and the fracture manger (200) may be implemented on the same computing device, or different computing systems connected by a network. In some embodiments, the high-resolution image source (250), the fracture manger (200) and/or other elements, including but not limited to network elements, user equipment, user devices, servers, and/or network storage devices may be implemented on computing systems similar to the computing system (600) shown and described in FIG. 6 below.

While FIG. 2 shows various configurations of components, other configurations may be used without departing from the scope of the disclosure. For example, various components in FIG. 2 may be combined to create a single component. As another example, the functionality performed by a single component may be performed by two or more components.

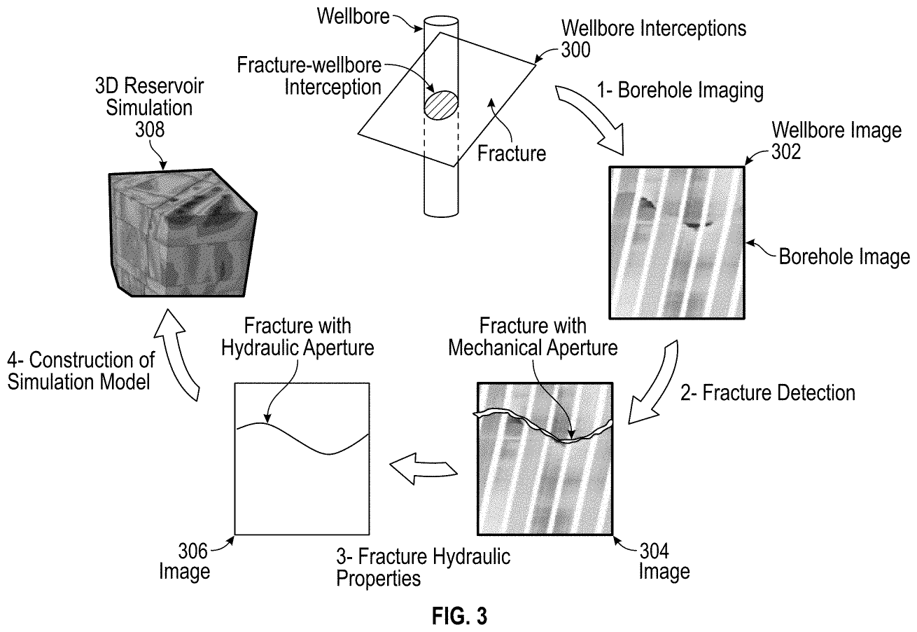

Turning to FIG. 3, FIG. 3 shows an overall workflow in accordance with one or more embodiments. Specifically, FIG. 3 describes a general workflow for an automatic process fracture detection, dynamic hydraulic properties estimation, as well as 3D reservoir simulation generation from high-resolution images. One or more steps in FIG. 3 may be performed by one or more components as described in FIG. 2, for example, the fracture manager (200) which may execute on any suitable computing device, such as the computer system shown in FIG. 6. While the various steps in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Step 1, high-resolution images are obtained from wellbores interceptions (300). Wellbore interceptions illustrate where a wellbore that is drilled intersects a fracture in the formation, as shown in 300. The high-resolution images include at least wellbore images, rock core images, and outcrop images. For example, the high-resolution images may refer to the wellbore images (251), rock core images (252) and the outcrop images (253) obtained by the data controller (220) as illustrated in FIG. 2. As shown in FIG. 3, wellbore images (302) are acquired, which may include different technologies, such as resistivity and acoustic logs, that has the capabilities to detect fracture or faults in the rock formation.

In Step 2, fractures are detected from the wellbore images utilizing a fracture detection model. The fractures may be detected from the fracture detection model (220) and may be represented by the fracture detections (260) as described in FIG. 2. As shown in image (304), a fracture typically appears as a sinusoidal shaped feature with visible contrast in the imaging signal reflecting the discontinuity in the rock property. The sinusoidal shape is a result of the folded circumference of the fracture plane intercepting the borehole.

In Step 3, dynamic hydraulic properties are generated based on the detected fractures from Step 2 and a hydraulic property estimation model. For example, the dynamic hydraulic properties may be generated by the hydraulic property estimation model (230) and may be represented by the dynamic hydraulic property estimations (270) as illustrated in FIG. 2. As shown in image (306), a fracture with hydraulic aperture is determined.

In Step 4, a 3D reservoir simulation (308) is generated. Specifically, the 3D reservoir simulation is generated based on the high-resolution images from Step 1, the fracture detections from Step 2, and the dynamic hydraulic property estimations from Step 3. The 3D reservoir simulation may be generated by the reservoir simulation model (240) and may be represented by the 3D reservoir simulations (280) as explained in FIG. 2. In some embodiments, a 3D reservoir simulation is a stochastic discrete fracture model generated by a spatial interpolation technique, and is usually scaled in kilometers (km).

Those skilled in the art will appreciate that the process of FIG. 3 may be repeated for any existing fractures in the formation as well as for any new wells that intersect a fracture in the formation.

Turning to FIG. 4, FIG. 4 provides an example of utilizing and generating a series of models to estimate dynamic hydraulic properties of a well. The following example is for explanatory purposes only and not intended to limit the scope of the disclosed technology.

In FIG. 4, a learned fracture detection model (e.g., fracture detection model (420)) may be one or more ML models trained by deep-learning algorithm (e.g., deep-learning algorithm (425)). Similar to the description in FIG. 2, the fracture detection model (420) may obtain high-resolution wellbore images of a well (e.g., wellbore images (410)) as inputs. Based on these inputs and the deep-learning algorithm (425), the fracture detection model (420) outputs fracture detections (e.g., fracture detections (460).

ML models include supervised ML models and unsupervised ML models. More specifically, supervised ML models include classification, regression models, etc. Unsupervised ML models include, for example, clustering models. Deep-learning algorithms are a part of ML algorithms based on artificial neural networks with representation learning. For example, the deep-learning algorithm may run data through multiple layers of neural network algorithms, each of which passes a simplified representation of the data to the next layer. More specifically, each artificial neural network consists a plurality of neurons that are staked next to each other and organized in layers. Each neuron may receive various inputs, multiplies the inputs by weights, sums them up, and applies a non-linear function.

In some embodiments, the fracture detection model (420) uses ML algorithms, such as the deep-learning algorithm (425), to identify and recognize fractures from the wellbore images (410) using an image segmentation technique, and outputs the identified and recognized fractures as the fracture detections (460). More specifically, the deep-learning algorithm (425) may utilize training based on pixel labeling of grey-scale images. Further, the deep-learning algorithm (425) may also utilize other image segmentation algorithms, such as Random Forest, which is based on probabilities of pixels.

In some embodiments, the deep-learning algorithm (425) may utilize U-Net procedure to generate the fracture detections (460). Specifically, the U-Net algorithm comprises two paths, a contracting path (also known as a convolutional path), and an expanding path (also known as a de-convolutional path). More specifically, the contracting path includes several cycles where each cycle has multiple repeating convolution operators (3×3), followed by a Rectified Linear Unit (ReLU), followed by a pool operator (2×2). The de-convolution path includes several cycles where each cycle has multiple repeating convolution operators (3×3), followed by a ReLU. Layer at the output end includes one convolution and one softmax.

However, the deep-learning algorithm (425) is not limited to this, and may be one or more neural network architectures, such as artificial neural networks (ANN), convolutional neural networks (CNN), recurrent neural networks, general adversarial neural networks, deep belief networks, autoencoders, etc.

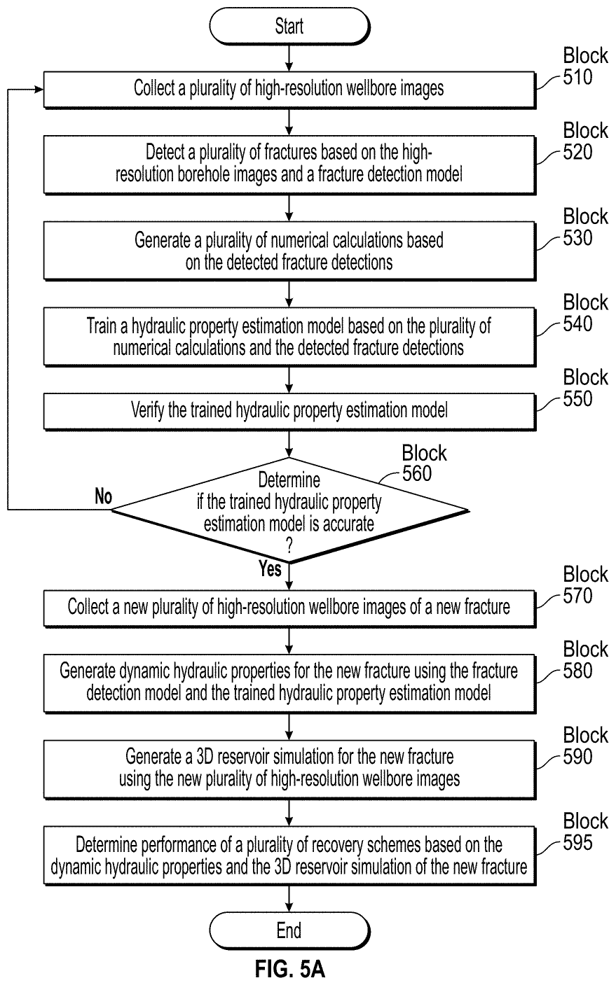

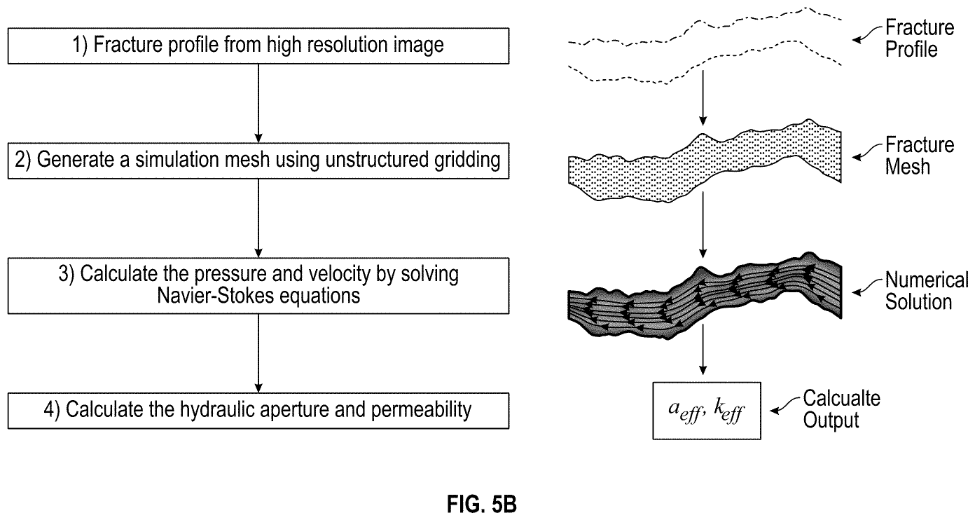

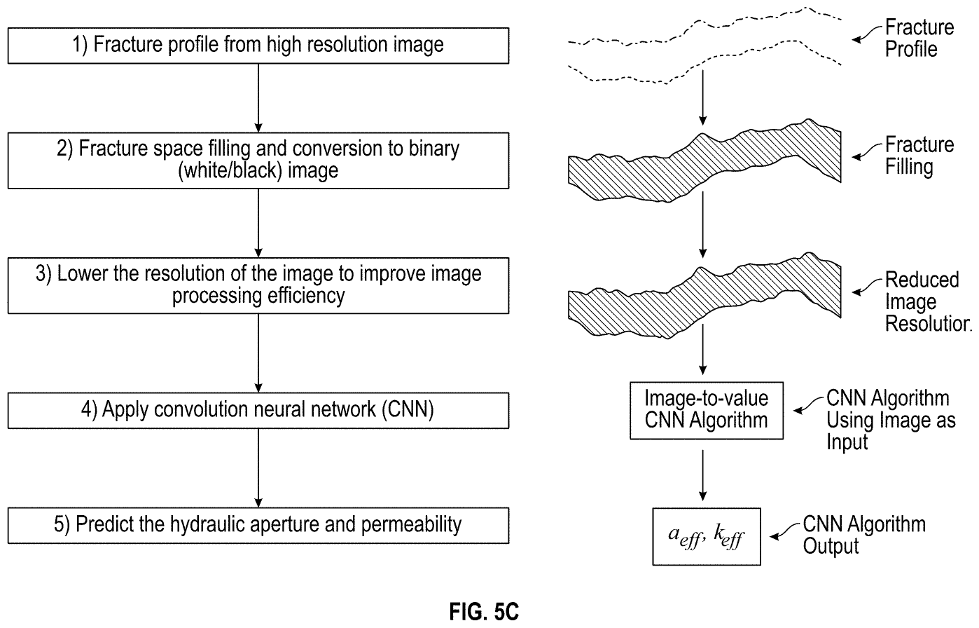

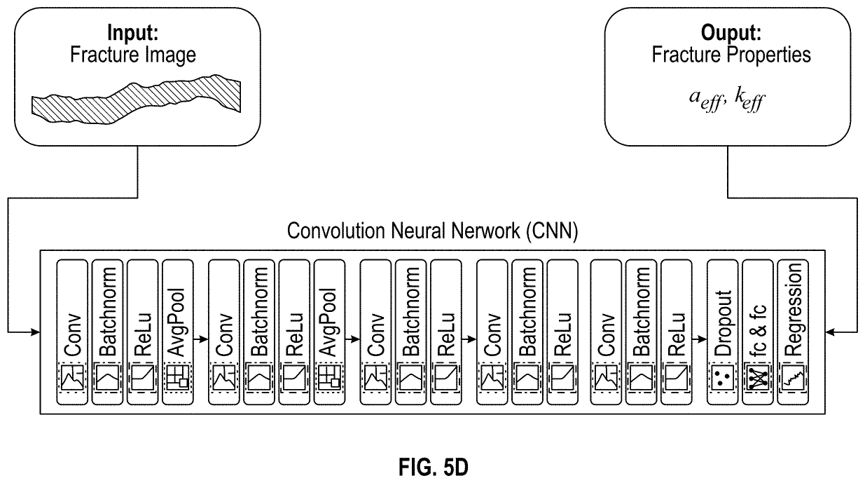

Keeping with FIG. 4, a hydraulic property estimation model (e.g., hydraulic property estimation model (430)) is generated in two parts. Specifically, in a first part, a plurality of sets of training data (e.g., training data (431)) are generated based on the fracture detections (460). The training data (431) comprises a set of values (e.g., numerical calculation results (432)) including fracture permeabilities and hydraulic apertures of actual and synthetic fractures. In a second part, the fracture detections (460), the training data (431), and a CNN algorithm (e.g., convolutional neural networks (CNN) algorithm (435)) are used to train and generate the hydraulic property estimation model (430). More details about training and generating the hydraulic property estimation model (430) are discussed below in FIG. 5A-5D and the accompanying description.

In some embodiments, the trained hydraulic property estimation model (430) takes the fracture detections (460) from the fracture detection model (420) as input, and estimates hydraulic property estimations (e.g., dynamic hydraulic property estimations (470)) corresponding to the fracture detections (460) as output. In particular, the dynamic hydraulic property estimations (470) include the fracture permeabilities and the hydraulic apertures are outputted.

In some embodiments, the wellbore images (410) may be collected from a new fracture of an existing or a new reservoir. By utilizing the fracture detection model (420) and the trained hydraulic property estimation model (430), dynamic hydraulic property estimations (470) corresponding to the newly collected wellbore images are generated.

While FIG. 4 shows various configurations of components, other configurations may be used without departing from the scope of the disclosure. For example, various components in FIG. 4 may be combined to create a single component. As another example, the functionality performed by a single component may be performed by two or more components.

Turning to FIG. 5A, FIG. 5A show a flowchart describing a method for generating a hydraulic property estimation model in accordance with one or more embodiments. For example, FIG. 5A shows detailed procedures of generating and verifying the hydraulic property estimation model (430) in FIG. 4. Specifically, FIG. 5 describes a training procedure that trains various ML models used by an automated procedure that identifies fractures and estimates hydraulic properties. One or more blocks in FIG. 5A may be performed by one or more components as described in FIG. 2, for example, the fracture manager (200), which may execute on a computing device such as that shown in FIG. 6. While the various blocks in FIG. 5A are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 510, a plurality of high-resolution wellbore images are obtained. For example, the obtained high-resolution wellbore images may be represented by the wellbore images (410) as shown in FIG. 4.

In Block 520, a plurality of fractures are detected and identified based on the wellbore images and a fracture detection model. For example, the fracture detection model may be the fracture detection model (420) as illustrated in FIG. 2. In other embodiments, the fracture detection model may use a deep learning, convolutional neural network (CNN) algorithm to capture the fracture mechanical aperture and roughness.

In Block 530, a plurality of numerical calculations are generated as training data based on the detected fracture detections. For example, Block 530 may refer to the first part of generating the hydraulic property estimation model (430), and the generated calculations may be the training data (430) as illustrated in FIG. 4. Specifically, the calculations are generated utilizing the Navier-Stokes equations. The Navier-stokes equations is a partial differential equation that describes the flow of incompressible fluids in fluid mechanics. In particular, Block 530 may generate thousands of sets of the training data (431), wherein each set of data consists a high-resolution image comprising a fracture and its corresponding hydraulic properties

More specifically, FIG. 5B shows an example of generating the numerical calculations. As shown in FIG. 5B, the numerical calculations are generated in four steps, obtain a fracture profile from a high resolution image, generate a simulation mesh using unstructured gridding, calculate pressure and velocity by solving Navier-Stokes equations (NSEs), and calculate the dynamic hydraulic properties including the fracture permeabilities k_{eff} and the hydraulic apertures a_{eff}. More specifically, detected fractures are labeled with top lines and bottom lines, wherein the top and bottom lines form the fracture profile. Unstructured mesh is generated due to the irregular shape of the fracture profile. In one or more embodiments, the simulation mesh may be generated by a mesh generator, such as Gmsh. Furthermore, the NSEs are considered as the most accurate approach for estimating hydraulic properties of fractures. Consider the steady-state of incompressible, Newtonian laminar flow with no gravity effects, full-physics NSEs are given as equation (1), wherein [symbol] is velocity vector, ρ is density, p is pressure, and μ is viscosity.

ρ( [symbol] ·∇ [symbol] )=−∇p+μ∇² [symbol] ∇· [symbol] =0 (1)

Continuing with FIG. 5A, in Block 540, a hydraulic property estimation model is trained. Specifically, the hydraulic property estimation model is trained by the plurality of fracture detections from Block 520 and the plurality of numerical calculations from Block 530. For example, Block 540 may refer to the second part of generating the hydraulic property estimation model (430) utilizing the CNN algorithm (435) as illustrated in FIG. 4. FIG. 5C shows an example of training the hydraulic property estimation model.

Specifically, as shown in FIG. 5C, the hydraulic property estimation model is trained in five steps, obtain fracture detections from the high resolution images, fill and converse fracture space to binary (black/white) images, lower resolution of the binary images to improve image processing efficiency, apply CNN procedures, and estimate dynamic hydraulic properties of the fracture permeabilities and the hydraulic apertures.

More specifically, high-fidelity discrete wellbore images including the fractures are pre-processed to generate input data for the a CNN model. Similar to those described in FIG. 5B, detected fractures are labeled with top and bottom lines to form the fracture profile as shown in step 1 of FIG. 5C. However, the fracture profile is formed by two rough and tortuous lines and has a substantial imbalance between fracture-occupied and non-fracture-occupied pixels, which results in difficulties in feature extraction during training processes. In addition, the fracture consisted with only two lines has significantly small percentages of pixel occupation.

To accelerates the feature extraction and training-validating processes, a filling-in process is conducted in Steps 2-3 to mark the zone bounded by the fracture profile, followed by an image-coarsening process. In particular, during the image-coarsening process, a 50×1000 pixel-resolution is applied. This resolution is a compromise between accuracy and efficiency, which is sufficient for characterizing the roughed fractures without significant loss of accuracy.

Furthermore, the region of interest (rectangle zone in Steps 2-3 of FIG. 5) is captured with a binary image, in which the black zone and non-black-zone (in Steps 2-3 of FIG. 5) occupied pixels are represented by 1 and 0, respectively. These processed fracture images are applied to the CNN model as input to obtain dynamic hydraulic properties of the fracture permeabilities and the hydraulic apertures as output.

In particular, FIG. 5D shows an example structure of the CNN procedures, where the fracture images are taken as input, and a series layers perform convolutions to predict dynamic hydraulic properties, including the fracture permeabilities k_{eff} and the hydraulic apertures a_{eff}, as output. More specifically, the CNN in FIG. 5D is designed to realize image-to-value function by modeling non-linear mappings between fracture images as input and fracture hydraulic apertures as output. The CNN includes various layers of different functionalities. Take FIG. 5D as an example, a convolution layer (Cony) is for main feature extraction; a Batch normalization layer (batchnorm) speeds up converge process; a ReLU layer (ReLU) reduces gradient descent vanishing issue; an average pooling layer (AvgPool) increases computational efficiency; the dropout layer (Dropout) prevents overfitting problem; a fully-connected layer (fc) flattens single vector; and the regression layer (Regression) is to generate continuous data. The CNN procedure captures the fracture mechanical aperture and roughness.

In Block 550, the trained hydraulic property estimation model from Block 540 is verified. In some embodiments, the verification utilizes the numerical calculations from Block 530. In particular, the calculations used for this verification may or may not be same as the calculations used for training the hydraulic property estimation model. More specifically, in order to obtain an accurate, efficient, and stable hydraulic property estimation model, relative error D of the generated model may range from −22% to 22%, with an essential normal distribution crossing the line of D=0 and most points located within D=±10%. In particular, accuracy of the generated model highly depends on accuracy of the training data that is used to train the model. In some embodiments, high-quality data from simulation and lab measurements are acquired to validate the hydraulic property estimation model. For example, a trained and verified hydraulic property estimation model may be represented by the hydraulic property estimation model (230) as shown in FIG. 2.

In Block 560, a determination as to whether the trained hydraulic property estimation model is accurate. If the trained model is determined as accurate, the flowchart moves to Block 570. If the answer to Block 560 is no, the flowchart loops back to Block 510, to update the trained model with newly collected wellbore images, and the process repeats until the trained model is determined as accurate.

In Block 570, a new plurality of high-resolution wellbore images of a new fracture are collected. These new images may be collected from a reservoir that is same as or different from the reservoir, from which the high-resolution wellbore images in Block 510 are collected.

In Block 580, dynamic hydraulic properties for the new fracture are generated using the fracture detection model and the trained hydraulic property estimation model.

In Block 590, a 3D reservoir simulation for the new fracture is generated using the new plurality of high-resolution wellbore images.

In Block 595, the hydraulic properties and the 3D reservoir simulation for the new fracture are used to determine performance of a plurality of recovery schemes designed for a reservoir that includes the new fracture. By obtaining permeability distribution of different fractures and rocks based on the 3D reservoir simulation, mathematical equations for fluid transport in each block of the 3D reservoir simulation can be solved. These mathematical equations are further used to predict produced hydrocarbon at the simulated reservoir and surface conditions, for example, reservoir and surface temperature, pressure, and water saturation.

Those skilled in the art will appreciate that the process of FIG. 5A may be repeated for any existing fractures in any reservoirs.

Turning to FIG. 6, FIG. 6 shows a computing system in accordance with one or more embodiments. As shown in FIG. 6, the computing system 600 may include one or more computer processor(s) 604, non-persistent storage 602 (e.g., random access memory (RAM), cache memory, or flash memory), one or more persistent storage 1706 (e.g., a hard disk), a communication interface 608 (transmitters and/or receivers) and numerous other elements and functionalities. The computer processor(s) 604 may be an integrated circuit for processing instructions. The computing system 600 may also include one or more input device(s) 620, such as a touchscreen, keyboard, mouse, microphone, touchpad, electronic pen, or any other type of input device. In some embodiments, the one or more input device(s) 620 may be the GUI (205) described in FIG. 2 and the accompanying description. Further, the computing system 600 may include one or more output device(s) 610, such as a screen (e.g., a liquid crystal display (LCD), a plasma display, or touchscreen), a printer, external storage, or any other output device. One or more of the output device(s) may be the same or different from the input device(s). The computing system 600 may be connected to a network system 630 (e.g., a local area network (LAN), a wide area network (WAN) such as the Internet, mobile network, or any other type of network) via a network interface connection (not shown).

In one or more embodiments, for example, the input device 620 may be coupled to a receiver and a transmitter used for exchanging communication with one or more peripherals connected to the network system 630. The receiver may receive information relating to hydraulic properties as described in FIGS. 2-5D. The transmitter may relay information received by the receiver to other elements in the computing system 600. Further, the computer processor(s) 604 may be configured for performing or aiding in implementing the processes described in reference to FIGS. 2-5D.

Further, one or more elements of the computing system 600 may be located at a remote location and be connected to the other elements over the network system 630. The network system 630 may be a cloud-based interface performing processing at a remote location from the well site and connected to the other elements over a network. In this case, the computing system 600 may be connected through a remote connection established using a 5G connection, such as protocols established in Release 15 and subsequent releases of the 3GPP/New Radio (NR) standards.

The computing system in FIG. 6 may implement and/or be connected to a data repository. For example, one type of data repository is a database (i.e., like databases). A database is a collection of information configured for ease of data retrieval, modification, re-organization, and deletion. In some embodiments, the databases include published/measured data relating to the method, the systems, and the devices as described in reference to FIGS. 2-5D.

While FIGS. 1-6 show various configurations of components, other configurations may be used without departing from the scope of the disclosure. For example, various components in FIGS. 2 and 6 may be combined to create a single component. As another example, the functionality performed by a single component may be performed by two or more components.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means- plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A method for fracture dynamic hydraulic properties estimation and reservoir simulation, comprising:
obtaining, by a computer processor, a first set of high-resolution images of a first fracture;
obtaining, by the computer processor and a first model, a first set of fracture detections based on the first set of high-resolution images;
generating, by the computer processor, a plurality of numerical calculations based on the first set of fracture detections of the first fracture;
generating, by the computer processor, a second model based on the plurality of numerical calculations and the first set of fracture detections;
obtaining, by the computer processor, a second set of high-resolution images of a second fracture of a new reservoir;
generating, by the computer processor using the first model, a second set of fracture detections of the second fracture;
generating, by the computer processor using the second model, dynamic hydraulic estimations of the second fracture;
generating, by the computer processor and a third model, a three-dimensional (3D) reservoir simulation of the new reservoir based on the second set of high-resolution images and the dynamic hydraulic estimations of the second fracture; and
determining, by the computer processor and using the dynamic hydraulic estimations of the second fracture and the 3D reservoir simulation, a plurality of recovery schemes for the new reservoir.

2. The method of claim 1,
wherein the first model is a model that employs a first machine-learning (ML) algorithm and uses the high-resolution images as inputs, and
wherein the second model is a model that employs a second ML algorithm and uses the fracture detections as inputs.

3. The method of claim 1, further comprising:
obtaining, by the computer processor, a third set of high-resolution images of a third fracture;
generating, by the computer processor using the first model and the second model, a third set of fracture detections based on the third set of high-resolution images; and
updating the second model, by the computer processor, using the third set of fracture detections and the third set of high-resolution images.

4. The method of claim 1, wherein the dynamic hydraulic estimations comprises fracture permeability and hydraulic aperture.

5. The method of claim 2, wherein the first ML algorithm is a deep-learning (DL) algorithm comprising U-Net procedure and the second ML algorithm is a DL algorithm comprising convolutional neural network (CNN) procedure.

6. The method of claim 1, wherein the high-resolution images comprise wellbore images, rock core images, and outcrop images.

7. The method of claim 1, wherein the first fracture, the second fracture, and the third fracture are obtained from a plurality of wells from one or more reservoirs.

8. A system for fracture dynamic hydraulic properties estimation and reservoir simulation, comprising:
a plurality sets of high-resolution images for a plurality fractures; and
a fracture manager comprising a computer processor, wherein the fracture manager is configured to:
obtain a first set of high-resolution images of a first fracture,
obtain, using a first model, a first set of fracture detections based on the first set of high-resolution images,
generate a plurality of numerical calculations based on the first set of fracture detections of the first fracture,
generate a second model based on the plurality of numerical calculations and the first set of fracture detections,
obtain a second set of high-resolution images of a second fracture of a new reservoir,
generate, using the first model, a second set of fracture detections of the second fracture,
generate, using the second model, dynamic hydraulic estimations of the second fracture,
generate, using a third model, a three-dimensional (3D) reservoir simulation of the new reservoir based on the second set of high-resolution images and the dynamic hydraulic estimations of the second fracture, and
determine, using the dynamic hydraulic estimations of the second fracture and the 3D reservoir simulation, a plurality of recovery schemes for the new reservoir.

9. The system of claim 8,
wherein the first model is a model that employs a first machine-learning (ML) algorithm and uses the high-resolution images as inputs, and
wherein the second model is a model that employs a second ML algorithm and uses the fracture detections as inputs.

10. The system of claim 8, further comprising:
obtain a third set of high-resolution images of a third fracture,
generate, using the first model and the second model, a third set of fracture detections based on the third set of high-resolution images, and
update the second model using the third set of fracture detections and the third set of high-resolution images.

11. The system of claim 8, wherein the dynamic hydraulic estimations comprises fracture permeability and hydraulic aperture.

12. The system of claim 8, wherein the first ML algorithm is a deep-learning (DL) algorithm comprising U-Net procedure and the second ML algorithm is a DL algorithm comprising convolutional neural network (CNN) procedure.

13. The system of claim 8, wherein the high-resolution images comprise wellbore images, rock core images, and outcrop images.

14. The system of claim 8, wherein the first fracture, the second fracture, and the third fracture are obtained from a plurality of wells from one or more reservoirs.

15. A non-transitory computer readable medium storing instructions executable by a computer processor, the instructions comprising functionality for:
obtaining a first set of high-resolution images of a first fracture;
obtaining, using a first model, a first set of fracture detections based on the first set of high-resolution images;
generating a plurality of numerical calculations based on the first set of fracture detections of the first fracture;
generating a second model based on the plurality of numerical calculations and the first set of fracture detections;
obtaining a second set of high-resolution images of a second fracture of a new reservoir;
generating, using the first model, a second set of fracture detections of the second fracture;
generating, using the second model, dynamic hydraulic estimations of the second fracture;
generating, using a third model, a three-dimensional (3D) reservoir simulation of the new reservoir based on the second set of high-resolution images and the dynamic hydraulic estimations of the second fracture; and
determining, using the dynamic hydraulic estimations of the second fracture and the 3D reservoir simulation, a plurality of recovery schemes for the new reservoir.

16. The non-transitory computer readable medium of claim 15,
wherein the first model is a model that employs a first machine-learning (ML) algorithm and uses the high-resolution images as inputs, and
wherein the second model is a model that employs a second ML algorithm and uses the fracture detections as inputs.

17. The non-transitory computer readable medium of claim 15, further comprising functionality for:
obtaining a third set of high-resolution images of a third fracture;
generating, using the first model and the second model, a third set of fracture detections based on the third set of high-resolution images; and
updating the second model using the third set of fracture detections and the third set of high-resolution images.

18. The non-transitory computer readable medium of claim 15, wherein the dynamic hydraulic estimations comprises fracture permeability and hydraulic aperture.

19. The non-transitory computer readable medium of claim 15, wherein the first ML algorithm is a deep-learning (DL) algorithm comprising U-Net procedure and the second ML algorithm is a DL algorithm comprising convolutional neural network (CNN) procedure.

20. The non-transitory computer readable medium of claim 15, wherein the high-resolution images comprise wellbore images, rock core images, and outcrop images.
